(19) United States
(12) Patent Application Publication
(10) Pub. No.: US 2026/0009495 A1
(43) Pub. Date: Jan. 8, 2026

(54) Two-Axis, Two-Linear Actuator Gimbal

(71) Applicant: Alex Deuitch, Westminster, CO (US)

(72) Inventor: Alex Deuitch, Westminster, CO (US)

(21) Appl. No.: 19/254,666

(22) Filed: Jun. 30, 2025

Related U.S. Application Data
(60) Provisional application No. 63/667,002, filed on Jul. 2, 2024.

(51) Int. Cl. F16M 11/10; B25J 17/02; F16M 11/20

(52) U.S. Cl. CPC F16M 11/10; F16M 11/2021; B25J 17/0258

(57) ABSTRACT

A gimbal is disclosed including a base plate with a pitch pivot about which an intermediate frame is configured to rotate in a pitch axis about the pitch pivot; a pitch linear actuator mounted between the base plate and the intermediate frame, wherein the pitch linear actuator is configured to extend and retract such that the intermediate frame rotates in the pitch axis about the pitch pivot; a mounting plate with a roll pivot about which the intermediate frame is configured to rotate in a roll axis about the roll pivot; and a roll linear actuator mounted between the mounting plate and the intermediate frame, wherein the roll linear actuator is configured to extend and retract such that the intermediate frame rotates in the roll axis about the roll pivot.

### CROSS-REFERENCE TO RELATED APPLICATIONS

This application claims the benefit of U.S. Provisional Patent Application No. 63/667,002 filed 2 Jul. 2024, which is incorporated by reference herein in its entirety

### TECHNICAL FIELD

This invention relates to gimbals. More specifically, this invention relates to two-axis, two-linear actuator gimbals.

### BACKGROUND OF THE INVENTION

Gimbals have been used for millennia. They are of special interest in spaceflight.

### SUMMARY

In a first example, the disclosure provides a gimbal including the following features. A base plate with a pitch pivot about which an intermediate frame is configured to rotate in a pitch axis about the pitch pivot. A pitch linear actuator is mounted between the base plate and the intermediate frame. The pitch linear actuator is configured to extend and retract such that the intermediate frame rotates in the pitch axis about the pitch pivot. A mounting plate with a roll pivot about which the intermediate frame is configured to rotate in a roll axis about the roll pivot. A roll linear actuator is mounted between the mounting plate and the intermediate frame. The roll linear actuator is configured to extend and retract such that the intermediate frame rotates in the roll axis about the roll pivot.

In some examples, the pitch linear actuator is mounted orthogonal to the pitch axis.

In some examples, the pitch linear actuator is mounted within a volume between the base plate and the intermediate frame.

In some examples, the roll linear actuator is mounted orthogonal to the roll axis.

In some examples, the roll linear actuator is mounted within a volume between the mounting plate and the intermediate frame.

In some examples, a first end of the pitch linear actuator mounts rotationally to a base pivot point and a second end of the pitch linear actuator mounts rotationally to a lower intermediate pivot point.

In some examples, a first end of the pitch linear actuator mounts to the base plate and a second end of the pitch linear actuator mounts to a linkage, nut, gear, or cam that induces rotation of the intermediate frame about the pitch axis.

In some examples, a first end of the roll linear actuator mounts rotationally to a mounting plate pivot point and a second end of the roll linear actuator mounts rotationally to an upper intermediate pivot point.

In some examples, a first end of the roll linear actuator mounts to the intermediate frame and a second end of the roll linear actuator mounts to a linkage, nut, gear, or cam that induces rotation of the mounting plate about the roll axis.

In some examples, the base plate is a stationary surface relative to the intermediate frame and the mounting plate, the stationary surface selected from the group consisting of a spacecraft body structure, a space station, a robotic arm, and a ground structure.

In some examples, the mounting plate carries a payload, the payload selected from the group consisting of a thruster, a mirror, an antenna, an optical sensor, a solar array, electronics, SADA, a pointing system, and a thruster valve.

In some examples, the pitch linear actuator consists of a piezoelectric linear actuator.

In some examples, the roll linear actuator consists of a piezoelectric linear actuator.

### BRIEF DESCRIPTION OF DRAWINGS

The following drawings are provided to illustrate certain examples described herein. The drawings are merely illustrative and are not intended to limit the scope of the present disclosure or the present claims, and are not intended to show every potential feature or embodiment of the present disclosure or the present claims. The drawings are not necessarily drawn to scale; in some instances, certain elements of the drawing may be enlarged with respect to other elements of the drawing for purposes of illustration.

FIG. 1 is a top view of a gimbal in a neutral position.

FIG. 2 is a left-side view of the gimbal of FIG. 1.

FIG. 3 is a back-side view of the gimbal of FIG. 1.

FIG. 4 is a right-side view of the gimbal of FIG. 1.

FIG. 5 is a front-side view of the gimbal of FIG. 1.

FIG. 6 is a left-back isometric view of the gimbal of FIG. 1 in a tilted position.

FIG. 7 is a back-right isometric view of the gimbal of FIG. 1 in the tilted position of FIG. 6.

FIG. 8 is a back-left isometric view of the gimbal of FIG. 1 in the neutral position.

FIG. 9 is a back-right isometric view of the gimbal of FIG. 1 in the neutral position.

FIG. 10 is a back-right isometric view of the gimbal of FIG. 1 in the neutral position.

FIG. 11 is a left-back isometric view of the gimbal of FIG. 1 in the tilted position of FIG. 7 with a mounted object.

FIG. 12 is a left-back isometric view of the gimbal of FIG. 1 in the tilted position of FIG. 6 with the mounted object of FIG. 11.

FIG. 13 is a top view of a gimbal in a neutral position.

FIG. 14 is a left side view of the gimbal of FIG. 13.

FIG. 15 is a front view of the gimbal of FIG. 13.

FIG. 16 is a back view of the gimbal of FIG. 13.

### DETAILED DESCRIPTION

The following description recites various example systems and methods disclosed herein. No particular example is intended to define the scope of the present systems and methods. Rather, the examples provide non-limiting examples of various systems, and methods, that are included within the scope of the present disclosure and the present claims. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” “illustratively,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed example.

As used herein, “linear actuator” is a device that creates linear motion. A body houses a shaft, rod, screw, or other similar object that is retained in the body until the actuation occurs, at which point the shaft extends out of the body. Mechanical actuators include screw, wheel and axle, and cam type actuators. Electro-mechanical actuators use electric motors for actuation. Pneumatic or hydraulic actuators use fluid forces to extend and retract the rod. Piezoelectric actuators utilize voltage to cause finely controlled actuation. Any of these types of linear actuators may be used anywhere linear actuators or actuation is mentioned, herein.

As used herein, “pitch,” “roll,” and “yaw” represent three axes but are not limiting to a specific axis. When “pitch” or “roll” are used, “yaw” could be substituted, and so on.

Gimbals allow objects to rotate about one or more axes. A common sort of actuated gimbal utilizes motors or similar that rotate the object by direct rotational force about that axis. One need for gimbals is to mount thrusters, as one example, to the side of spaceships. These and other applications require the thruster to mount on a two-axis gimbal. Standard two-axis gimbals are bulky. In the present invention, a two-axis gimbal is disclosed with a pair of linear actuators. Each of the linear actuators acts to cause rotation about one of the two axes, by modifying the pitch or roll of the gimbal. When both actuate, the gimbal rotates in both axes simultaneously. Note that the terms pitch, roll, and yaw are commonly used in discussion of gimbals and that while pitch and roll are used to discuss the axes of rotation, pitch, roll, or yaw could all be used interchangeably, as long as they are used consistently.

The pitch linear actuator mounts rotationally at the body to the main frame of the gimbal and rotationally on the shaft to the intermediate frame of the gimbal. The intermediate frame of the gimbal is rotatable on the pitch axis. As the pitch linear actuator actuates, the shaft extends. As both the body of the pitch linear actuator and the shaft are rotationally mounted at their respective locations, the extension of the shaft causes both ends to rotate. The rotation at the body end causes the pitch linear actuator to tilt away from the main frame. The rotation about the shaft causes the intermediate frame to rotate about the pitch axis. The combined rotation of both pivots of the pitch linear actuator and its shaft allow for control of the pitch axis for the gimbal.

The roll linear actuator mounts rotationally at the body to the top frame of the gimbal and rotationally on the shaft to the intermediate frame of the gimbal. The top frame of the gimbal is rotatable on the roll axis. As the roll linear actuator actuates, the shaft extends. As both the body of the roll linear actuator and the shaft are rotationally mounted at their respective locations, the extension of the shaft causes both ends to rotate. The rotation about the shaft causes the shaft to tilt away from the intermediate frame. The rotation at the body end causes the roll linear actuator to tilt away from the top frame. The combined rotation of both pivots of the roll linear actuator and its shaft allow for control of the roll axis for the gimbal.

In this manner, a two-axis gimbal is provided by a two-actuator system, each actuator radially offset from each pivoting axis.

A significant improvement of the present invention over any other gimbal is the compact design. Each of the linear actuators is within the gimbal volume. The pitch linear actuator is mounted between the rotating points of the pitch axis on the main frame, under the intermediate frame. The roll linear axis is mounted to the underside of the top frame, above the intermediate frame, and between the rotating points of the roll axis of the top frame. As such, there are no parts that extend beyond the top frame, resulting in a gimbal that is compact beyond anything available in the art. This is of special benefit for outer space applications. In some examples, the linear actuators, while still within the gimbal volume, are not between the rotating points of their respective sections.

As each of the linear actuators mount to the frames rotationally, there are no off-linear loads on the nuts holding them in place, or on the linear actuators.

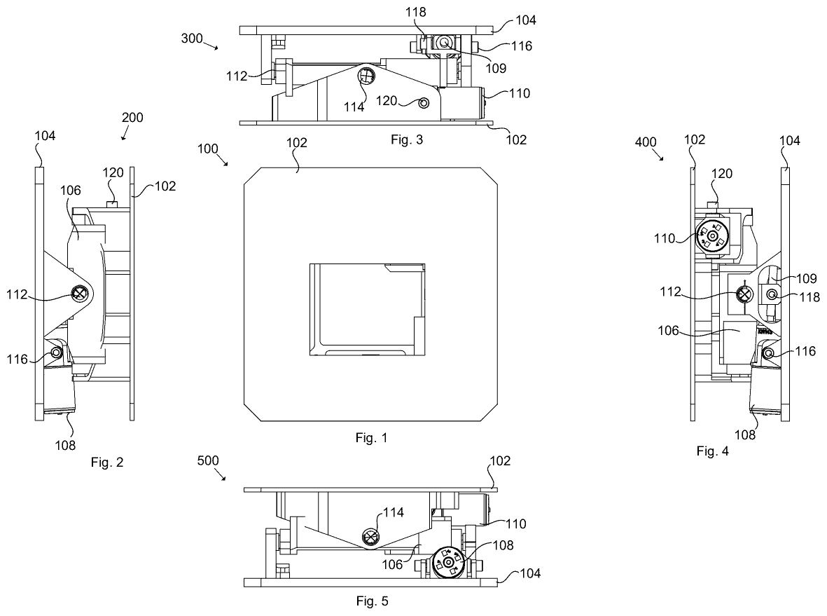

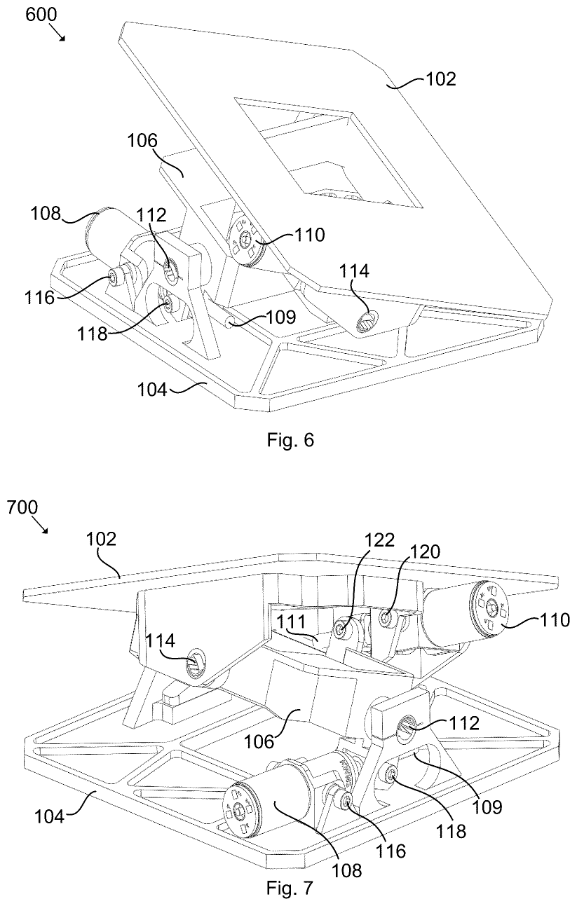

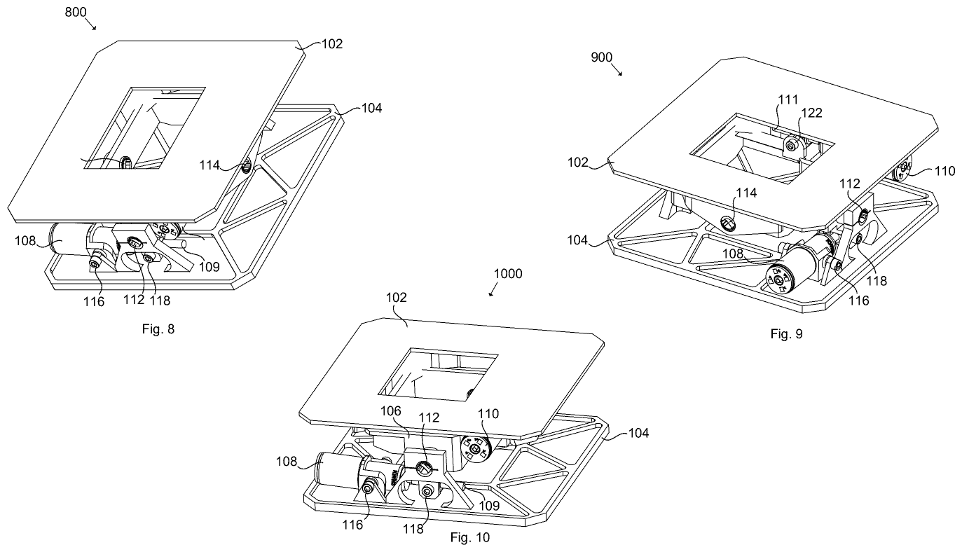

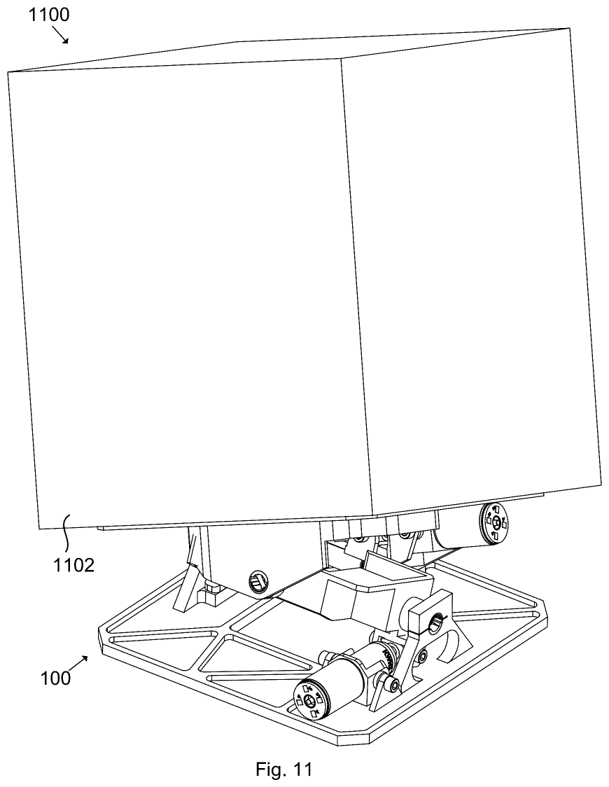

Now referring to the Figures, FIG. 1 is a top view of a gimbal in a neutral position showing an example device 100 that may be used in some examples provided herein. FIG. 2 is a left-side view of the gimbal of FIG. 1 at 200. FIG. 3 is a back-side view of the gimbal of FIG. 1 at 300. FIG. 4 is a right-side view of the gimbal of FIG. 1 at 400. FIG. 5 is a front-side view of the gimbal of FIG. 1 at 500. FIG. 6 is a left-back isometric view of the gimbal of FIG. 1 in a tilted position at 600. FIG. 7 is a back-right isometric view of the gimbal of FIG. 1 in the tilted position of FIG. 6 at 700. FIG. 8 is a back-left isometric view of the gimbal of FIG. 1 in the neutral position at 800. FIG. 9 is a back-right isometric view of the gimbal of FIG. 1 in the neutral position at 900. FIG. 10 is a back-right isometric view of the gimbal of FIG. 1 in the neutral position at 1000.

The gimbal 100 is one example and other examples are anticipated by the design and examples shown herein. The gimbal consists of three frame pieces, the base plate 104, the mounting plate 102, and an intermediate frame 106. The base plate 104 has a pivot point 112 about which the intermediate frame 106 can rotate in what is referred to in this example as the pitch axis. The mounting plate 102 has a pivot point 114 about which the intermediate frame 106 can rotate, resulting in the mounting plate 102 rotating in what is referred to in this example as the roll axis.

A pitch linear actuator 108 is mounted to the base plate 104 via a bolt that acts as pivot axis 116. The linear arm 109 attaches to the intermediate frame via another bolt that acts as pivot axis 118. The roll linear actuator 110 is mounted to the mounting plate 102 via a bolt that acts as a pivot axis 120. The linear arm 111 attaches to the intermediate frame via another bolt that acts as pivot axis 122. In other examples, rather than a bolt, the pivot axis 116 could be a rotational faster, a pin, or similar rotational items.

In other examples, these actuators may be mounted opposite—with the actuator mounted to the intermediate frame 106 and the linear arms to the plates, either individually or as a pair.

In the example of the Figures, the linear actuators are mounted entirely within the footprints of the pivot points 112 and 114, respectively, producing a minimal volume gimbal. This compactness is of special interest in outer space applications.

The pitch linear actuator 108 actuates the linear arm 109, extending or retracting the linear arm. As the linear arm and linear actuator are mounted above and below to the intermediate frame 106 and base plate 104, respectively, as they extend and retract, they rotate about their respective pivot points 116 and 118, forcing the intermediate frame 106 to rotate in the pitch axis.

The roll linear actuator 110 actuates the linear arm 111, extending or retracting the linear arm. As the linear arm and linear actuator are mounted above and below to the mounting plate 102 and intermediate frame 106, respectively, as they extend and retract, they rotate about their respective pivot points 120 and 122, forcing the intermediate frame 106 to rotate in the roll axis.

In the previous example, the linear actuator moves a rod back and forth. In other examples, the linear actuator uses a lead screw, ball screw, or other actuator with threading. As a captured thread rod, the threaded rod moves the captured nut up or down the threaded road. Using a threaded rod has a benefit in that the rod is not back drivable, eliminating the need for a brake to be used in zero gravity.

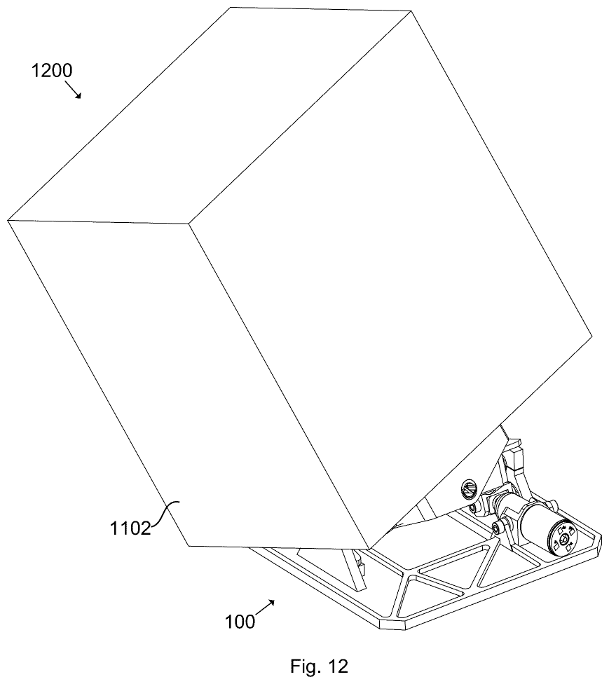

FIG. 11 is a left-back isometric view of the gimbal of FIG. 1 in the tilted position of FIG. 7 with a mounted object at 1100 that may be used in some examples provided herein. FIG. 12 is a left-back isometric view of the gimbal of FIG. 1 in the tilted position of FIG. 6 with the mounted object of FIG. 11 at 1200. The mounted object 1102 mounts to the mounting plate 102 of FIGS. 1 through 10. Rotation of this mounted object is one of the primary reasons for having a gimbal. Examples of items that the mounted object could be include but are not limited to, a chemical, electrical, thermal or any type of propulsion thruster; a non-propellant based thruster; antennas; cameras; optical sensors; reaction wheels; positional sensors; docking mechanisms; and lasers.

In one example, the entire device is 3D printed as a single unit. In one example, this is metal printed. In other examples, this is plastic printed. All options may include printing the pivot axes, as well, producing the entire gimbal structure, save the linear actuators, as a single unit.

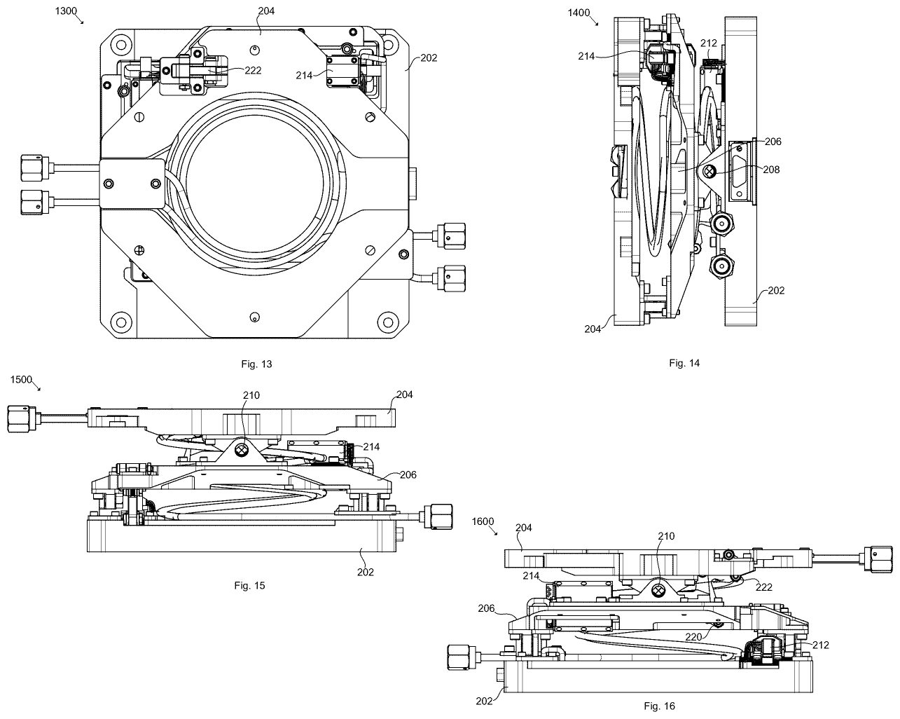

FIG. 13 is a top view of a gimbal in a neutral position showing an example device 1300 that may be used in some examples provided herein. FIG. 14 is a left side view 1400 of the gimbal of FIG. 13. FIG. 15 is a front view 1500 of the gimbal of FIG. 13. FIG. 16 is a back view 1600 of the gimbal of FIG. 13.

The gimbal 1300 is one example and other examples are anticipated by the design and examples shown herein. The gimbal consists of three frame pieces, the base plate 202, the mounting plate 204, and an intermediate frame 206. The base plate 202 has a pivot point 208 about which the intermediate frame 206 can rotate in what is referred to in this example as the pitch axis. The mounting plate 204 has a pivot point 210 about which the intermediate frame 206 can rotate, resulting in the mounting plate 204 rotating in what is referred to in this example as the roll axis.

A pitch linear actuator 212 is affixed to the base plate 202 and extends and retracts linkages that attach to the intermediate frame 206 and cause rotation about the pivot axis 208, resulting in change in pitch angle.

The roll linear actuator 214 is affixed to the intermediate plate 206 and extends and retracts linkages such as 220 and 222 that attach to the mounting plate 204 and cause rotation about the pivot axis 210, resulting in change in roll angle.

In other examples, these actuators may be mounted opposite.

The invention has been described with reference to various examples. Nevertheless, it is understood that many variations and modifications may be made while remaining within the spirit and scope of the invention.

1. A gimbal comprising:
a base plate comprising a pitch pivot about which an intermediate frame is configured to rotate in a pitch axis about the pitch pivot;
a pitch linear actuator mounted between the base plate and the intermediate frame, wherein the pitch linear actuator is configured to extend and retract such that the intermediate frame rotates in the pitch axis about the pitch pivot;
a mounting plate comprising a roll pivot about which the intermediate frame is configured to rotate in a roll axis about the roll pivot; and
a roll linear actuator mounted between the mounting plate and the intermediate frame, wherein the roll linear actuator is configured to extend and retract such that the intermediate frame rotates in the roll axis about the roll pivot.

2. The gimbal of claim 1, wherein the pitch linear actuator is mounted orthogonal to the pitch axis.

3. The gimbal of claim 2, wherein the pitch linear actuator is mounted within a volume between the base plate and the intermediate frame.

4. The gimbal of claim 1, wherein the roll linear actuator is mounted orthogonal to the roll axis.

5. The gimbal of claim 4, wherein the roll linear actuator is mounted within a volume between the mounting plate and the intermediate frame.

6. The gimbal of claim 1, wherein a first end of the pitch linear actuator mounts rotationally to a base pivot point and a second end of the pitch linear actuator mounts rotationally to a lower intermediate pivot point.

7. The gimbal of claim 1, wherein a first end of the pitch linear actuator mounts to the base plate and a second end of the pitch linear actuator mounts to a linkage, nut, gear, or cam that induces rotation of the intermediate frame about the pitch axis.

8. The gimbal of claim 1, wherein a first end of the roll linear actuator mounts rotationally to a mounting plate pivot point and a second end of the roll linear actuator mounts rotationally to an upper intermediate pivot point.

9. The gimbal of claim 1, wherein a first end of the roll linear actuator mounts to the intermediate frame and a second end of the roll linear actuator mounts to a linkage, nut, gear, or cam that induces rotation of the mounting plate about the roll axis.

10. The gimbal of claim 1, wherein the base plate is a stationary surface relative to the intermediate frame and the mounting plate, the stationary surface selected from the group consisting of a spacecraft body structure, a space station, a robotic arm, and a ground structure.

11. The gimbal of claim 1, wherein the mounting plate carries a payload, the payload selected from the group consisting of a thruster, a mirror, an antenna, an optical sensor, a solar array, electronics, SADA, a pointing system, and a thruster valve.

12. The gimbal of claim 1, wherein the pitch linear actuator comprises a piezoelectric linear actuator.

13. The gimbal of claim 1, wherein the roll linear actuator comprises a piezoelectric linear actuator.
